(19) United States
(12) Patent Application Publication
(10) Pub. No.: US 2017/0122826 A1
(43) Pub. Date: May 4, 2017

(54) Sensors Having Multiple Fiber-Grating Sensing Elements That Provide Differing Responses to an Environmental Input and Related Systems and Methods

(71) Applicant: Wicor Holding AG, Rapperswill (CH)

(72) Inventors: Eric Udd, Fairview, OR (US); David J. Woodcock, Lyndonville, VT (US)

(21) Appl. No.: 15/339,251

(22) Filed: Oct. 31, 2016

Related U.S. Application Data
(60) Provisional application No. 62/248,569, filed on Oct. 30, 2015.

(51) Int. Cl. G01L 11/02; G01N 21/17

(52) U.S. Cl. CPC G01L 11/025; G01N 21/17; G01N 2021/1761

(57) ABSTRACT

Sensors for measuring an environmental input, such as force or moisture, that include fiber-grating sensing elements having differing responses to the environmental input such that the differing responses can be used to effectively solve multiple equations, representing the differing responses, for two unknowns representing, respectively, the environmental input and temperature. The differing responses can be due to any one or more of a variety of factors, including sensor elements having differing effective areas, materials of differing cure states, differing fiber grating wavelengths, differing sensitive materials, asymmetrical deployments, and differing numbers of load balancing elements, among others. Sensor systems employing such sensors and methods of utilizing such sensors are also disclosed.

### RELATED APPLICATION DATA

This application claims the benefit of priority of U.S. Provisional Patent Application Ser. No. 62/248,569, filed on Oct. 30, 2015, and titled “FIBER GRATING FORCE, TEMPERATURE, MOISTURE AND ACOUSTIC SENSORS”, which is incorporated by reference herein in its entirety.

### FIELD OF THE INVENTION

The present invention generally relates to the field of fiber grating sensors. In particular, the present invention is directed to sensors having multiple fiber-grating sensing elements that provide differing responses to an environmental input and related systems and methods.

### BACKGROUND

Fiber gratings are well known and have been used for measuring axial and transverse loads. Applications of these fiber gratings have been used primarily to measure strain fields in composite materials and in adhesive joints. To measure transverse loads, some conventional sensors rely on embodiments that apply transverse load on an optical fiber. The transverse load induces differential strain across the optical core. This causes the optical core to manifest two different effective indices of refraction and two “effective” fiber gratings spaced relative to the induced index of refraction difference. These principals have been applied to measure transverse strain/load in a variety of applications.

There are a number of significant issues with the conventional sensors that measure transverse load. One issue is that the amount of birefringence induced by small to moderate transverse loads is very small. Significant efforts are required to accurately read out these differences and that in turn drives up cost. An alternative is to mechanically amplify the transverse load. This results in larger sensors, increased cost, and in some cases a need for high precision in alignment and fabrication methods. For some applications in which transverse load sensors are subject to high electrical fields, it is important to eliminate air gaps. This requirement makes it more difficult to employ some conventional geometries, including geometries utilizing side-hole optical fibers.

### SUMMARY OF THE DISCLOSURE

In one implementation, the present disclosure is directed to a sensor that includes a first fiber-grating sensing element designed and configured to sense a first environmental input, and a second fiber-grating sensing element designed and configured to sense the first environmental input wherein the first and second fiber-grating sensing elements are configured, constructed, and/or deployed so as to have differing measured responses to the first environmental input.

In another implementation, the present disclosure is directed to a sensor for measuring a magnitude of an environmental input. The sensor includes an optical fiber having a fiber grating, an elastic deformable coating surrounding the fiber grating, and an outer coating on the elastic deformable coating, the outer coating being harder than the elastic deformable coating and being responsive to the environmental input by expanding and contracting depending on the magnitude of the environmental input.

In yet another implementation, the present disclosure is directed to a sensor for measuring moisture and temperature. The sensor includes an optical fiber having first and second fiber gratings spaced apart along the optical fiber, the optical fiber being coated with an elastic deformable material; a relatively thick polyimide coating being disposed on the elastic deformable material at the first fiber grating; and a relatively thin polyimide coating being disposed on the elastic deformable material at the second fiber grating.

In still another implementation, the present disclosure is directed to a sensor that includes a pair of pressure transduction plates, an optical fiber having a first fiber grating and a second fiber grating and being coated with an elastic deformable material, wherein a portion of the optical fiber is bonded between the pressure transduction plates so that the first and second fiber gratings are located between the pressure transduction plates and so that, upon application of a transverse force orthogonally to a plane of the pressure transduction plates, the elastic deformable material causes longitudinal strain on the first and second fiber gratings.

In a further implementation, the present disclosure is directed to a method of measuring an environmental input other than temperature. The method includes receiving a first signal reflected from a first grating of a first fiber-grating sensing element designed, configured, and/or deployed to sense the environmental input with a first response to the environmental input, wherein the first signal is affected by temperature; receiving a second signal reflected from a second grating of a second fiber-grating sensing element designed, configured, and/or deployed to sense the environmental input with a second response to the environmental input that is different from the first response, wherein the second signal is affected by temperature; and using the first and second signals to effectively solve two equations for two unknown variables, representing, respectively, the environmental input and the temperature, so as to determine a measurement for the environmental input.

In still yet another implementation, the present disclosure is directed to a sensor system for measuring an environmental input other than temperature. The sensor system includes a first fiber-grating sensing element designed, configured, and/or deployed to sense the environmental input with a first response to the environmental input; a second fiber-grating sensing element designed, configured, and/or deployed to sense the environmental input with a second response to the environmental input that is different from the first response; a readout system designed and configured to receive a first signal from the first fiber-grating sensing element that represents the first response; receive a second signal from the second fiber-grating sensing element that represents the second response; and determine a measurement for the environmental input by effectively solving two equations having two unknowns representing, respectively, the environmental input and temperature.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a graph of wavelength versus pressure for a test sensor, showing the response of the sensor the first time through a pressure cycle at each test temperature, adjusted for temperature compensation;

FIG. 1A is a graph of wavelength versus pressure for the test sensor referred to in FIG. 1, showing the response of the sensor at 50° C. after each temperature cycle with temperature compensation;

FIG. 2 is a graph of wavelength versus pressure for the test sensor referred to in FIGS. 1 and 1A, showing the response of the sensor at 50° C. between temperature cycles after a 150° C. cure cycle with temperature compensation;

FIG. 3 is an idealized graph of wavelength versus pressure illustrating the linear nature of the response of the test sensor of FIGS. 1, 1A, and 2 the first time through a pressure cycle at a test temperature;

FIG. 4 is an idealized graph of wavelength versus pressure illustrating the non-linear nature of the response of the test sensor of FIGS. 1, 1A, and 2 for pressure cycles at various temperature following the first time through a pressure cycle;

FIG. 5 is an idealized graph of wavelength versus pressure illustrating the non-linear nature of the response of the test sensor of FIGS. 1, 1A, and 2, for a pressure cycle after a 150° C. cure;

FIG. 6 is a diagram illustrating an exemplary force/temperature (F/T) sensor having two force fiber-grating sensing elements, namely, a pre-cure F fiber-grating sensing element and a post-cure F fiber-grating sensing element that provide differing responses to a commonly applied load;

FIG. 7 is a partial isometric and cross-sectional view of an exemplary 7-fiber-position F/T fiber-grating sensing element that can be used in a sensor made in accordance with the present disclosure;

FIG. 8 is a partial isometric and cross-sectional view of the F/T fiber-grating sensing element of FIG. 7 modified to remove certain fibers so as to change the response of the F/T fiber-grating sensing element;

FIG. 9 is a partial isometric and cross-sectional view of the F/T fiber-grating sensing element of FIG. 7 modified differently relative to FIG. 8 to remove certain fibers so as to change the response of the F/T fiber-grating sensing element;

FIG. 10 is a partial isometric and cross-sectional view of the F/T fiber-grating sensing element of FIG. 7 modified differently relative to FIGS. 8 and 9 to remove certain fibers so as to change the response of the F/T fiber-grating sensing element;

FIG. 11 is a diagram illustrating an exemplary F/T sensor that comprises two F/T fiber-grating sensing elements selected in various combinations of the F/T fiber-grating sensing elements of FIGS. 8-10 so as to provide differing responses as between the two F/T fiber-grating sensing elements;

FIG. 12 is a diagram illustrating an exemplary F/T sensor having two F/T fiber-grating sensing elements of differing areas so as to provide differing responses as between the two F/T fiber-grating sensing elements;

FIG. 13 is a diagram illustrating an exemplary moisture (M) sensor the comprises two M fiber-grating sensing elements configured to have differing responses to a common environmental input;

FIG. 14 is a diagram illustrating an exemplary M/T sensor based on the M sensor of FIG. 13;

FIG. 15 is a diagram illustrating an exemplary F/M sensor combined with an acoustic (A) fiber-grating sensing element to form an F/M/A sensor;

FIG. 16A is a diagram illustrating an exemplary acoustic fiber-grating sensing element having multiple layers;

FIG. 16B is a diagram illustrating another exemplary acoustic sensor comprising an optical fiber wrapped around a mandrel;

FIG. 17 is a diagram illustrating an exemplary single-ended F/M/T/A sensor; FIG. 18 is a diagram illustrating a set of N double-ended F/M/T/A sensors; FIG. 19 is a diagram illustrating a set of N single-ended F/M/T/A sensors connected to a corresponding set of N feed-through lines passing through a wall panel;

FIG. 20 is a diagram illustrating a set of five single ended F/M/T/A sensor series connected to one another and to a pair of feed-through lines;

FIG. 21 is a diagram illustrating a sensing system comprising a set of eight F/M/T/A sensors connected to a single port of a multiport readout unit using a power divider or wavelength division multiplexing (WDM) unit;

FIG. 22 is a diagram illustrating a sensing system comprising a set of F/M/T/A sensors connected to a single port of the multiport readout unit of FIG. 21 using a single feed-through line;

FIG. 23 is a diagram illustrating a sensing system having eight F/M/T/A sensors and a power divider or WDM unit located in a lower temperature region than the F/M/T/A sensors;

FIG. 24 is a diagram illustrating an exemplary F/T sensor having a pair of fiber gratings of differing wavelengths located within a deformable jacket;

FIG. 25 is a diagram illustrating an exemplary F/T sensor similar to the F sensor of FIG. 24 but in which the fiber gratings are superposed with one another;

FIG. 26 is a diagram illustrating a birefringent fiber having a single fiber grating applied thereto so as to effectively provide two fiber gratings that can have differing responses to environmental loadings;

FIG. 27 is a diagram illustrating an exemplary F/T sensor that includes a birefringent fiber and a deformable jacket, wherein the birefringent fiber has a single fiber grating that effectively provides two fiber gratings that can have differing responses to environmental loadings;

FIG. 28A is a diagram illustrating an exemplary F/T sensor having a pair of single-ended F/T fiber-grating sensing elements located symmetrically within the F/T sensor;

FIG. 28B is a diagram illustrating an exemplary F/T sensor having a pair of fiber gratings connected in series with one another and located symmetrically within the F/T sensor;

FIG. 29A is a diagram illustrating an exemplary F/T sensor having a pair of fiber gratings located asymmetrically within the F/T sensor, wherein the fiber gratings have the same wavelength as one another;

FIG. 29B is a diagram illustrating an exemplary F/T sensor similar to the F/T sensor of FIG. 29A but having fiber gratings of differing wavelengths;

FIG. 30 is a diagram illustrating an exemplary plate that can be used to support multiple fibers, wherein grooves in the plate having differing sizes; and

FIG. 31 is a diagram illustrating an exemplary F/T sensor having a pair of fiber gratings located in regions having differing hardness relative to one another so as to cause the fiber gratings to have differing responses to a common environmental loading.

### DETAILED DESCRIPTION

In some aspects, the present invention is directed to fiber-grating-based sensors having at least two fiber-grating sensing elements having configurations, constructions, and/or deployments that differ from one another so as to cause the fiber-grating sensing elements to have differing loadings and, therefore, differing responses to the environmental input being measured. For example, if the environmental input being measured is force, the two fiber-grating sensing elements may be designed to receive differing portions of that force. As another example, if the environmental input being measured is moisture, the two fiber-grating sensing elements may be designed with differing size moisture-sensitive sleeves. When the environmental input desired to be measured is an environmental input other than temperature, such as force or moisture content, having two differing responses to the desired environmental input effectively provides two equations each having two unknowns and allows for temperature compensation. Various examples of fiber-grating-based sensors based on providing at least two fiber-grating sensing elements having intentionally differing responses are described below. In some aspects, the present invention is directed to economical ways of configuring fiber-grating-based sensors, including the two-sensing-element sensors noted above, while in further aspects, the present invention is directed to economical ways of implementing fiber-grating-based sensor systems, for example, in electrical transformer application. These and other aspects are described below in detail.

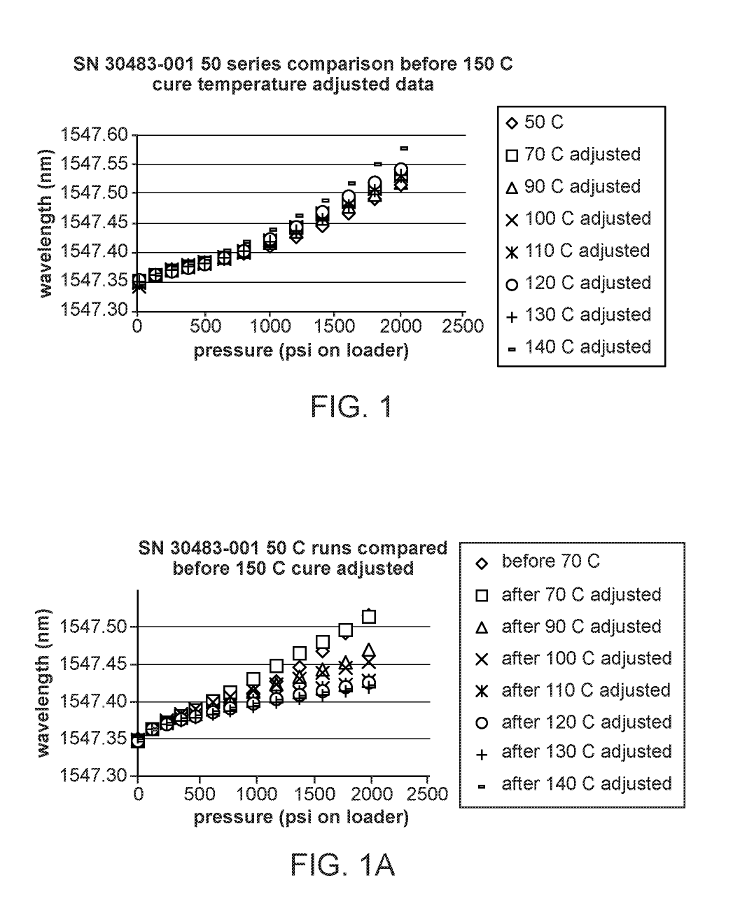

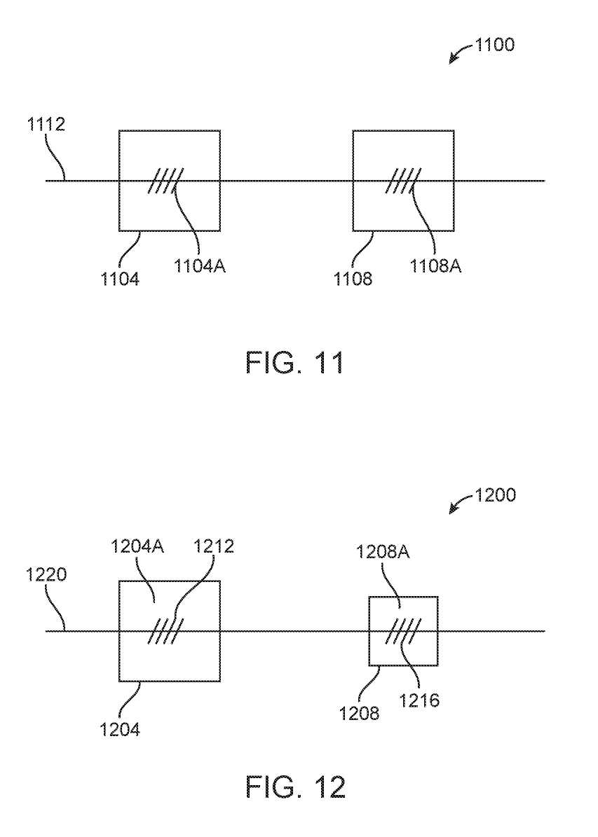

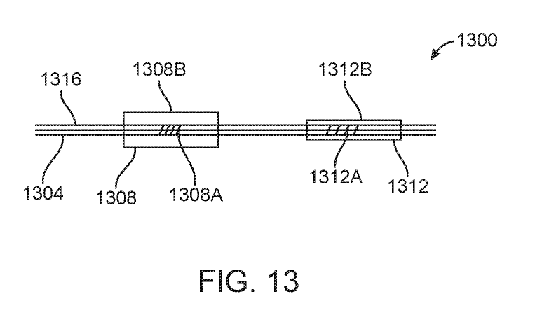

Referring now to the drawings, FIG. 1 shows the response of an exemplary force/temperature (F/T) sensor with a seven v-groove arrangement (not shown) similar to the five v-groove arrangement shown in FIG. 11 of the U.S. patent application Ser. No. 14/262,137, filed on Apr. 25, 2014, in the name of the Eric Udd (now U.S. Pat. No. 9,453,771) (“the '137 application”). In one embodiment, the top and bottom plates are 25 mm square, and 125 micron optical fibers, coated with ORMOCER® 2 for an overall diameter of 190 microns, are placed in the v-grooves and bonded using Optocast 3505 epoxy. A UV (ultraviolet) transparent quartz plate is used for the top plate and ceramic is used for the seven v-groove bottom plate. The processing method used is exposure to UV light through the quartz plate only for approximately 5 minutes. A prototype unit of this type was built. Strain relief shelves similar to the shelf associated with FIG. 13 of the '137 application were built on both sides of the v-groove bottom plate to support strain relief in the fiber leading to the output connector and a free floating fiber grating at the opposite end of the structure intended to support. They were installed into Nomex housings and subject to extensive testing at selected temperatures. The disclosure of the '137 application is incorporated herein by reference for all of its teachings of transverse force sensors and their applications, such as their applications in electrical transformers.

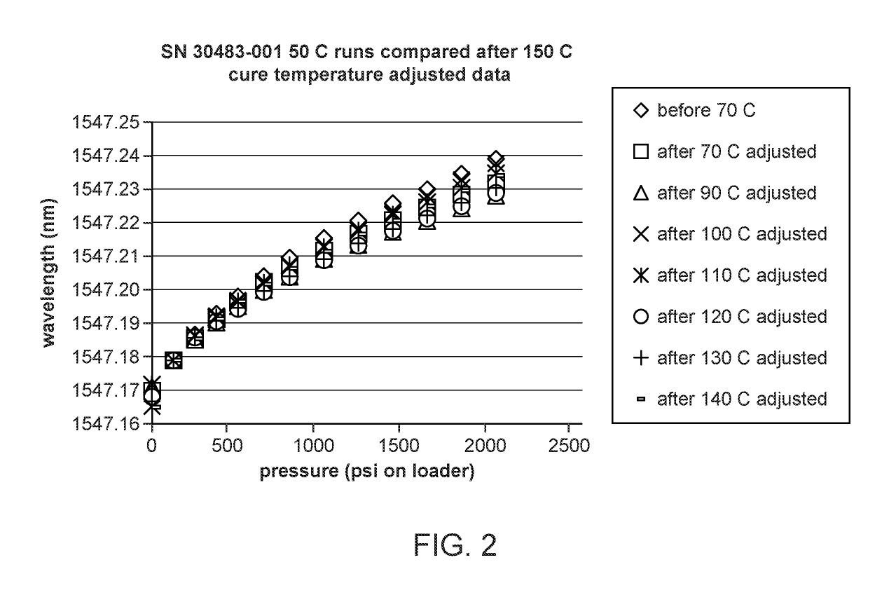

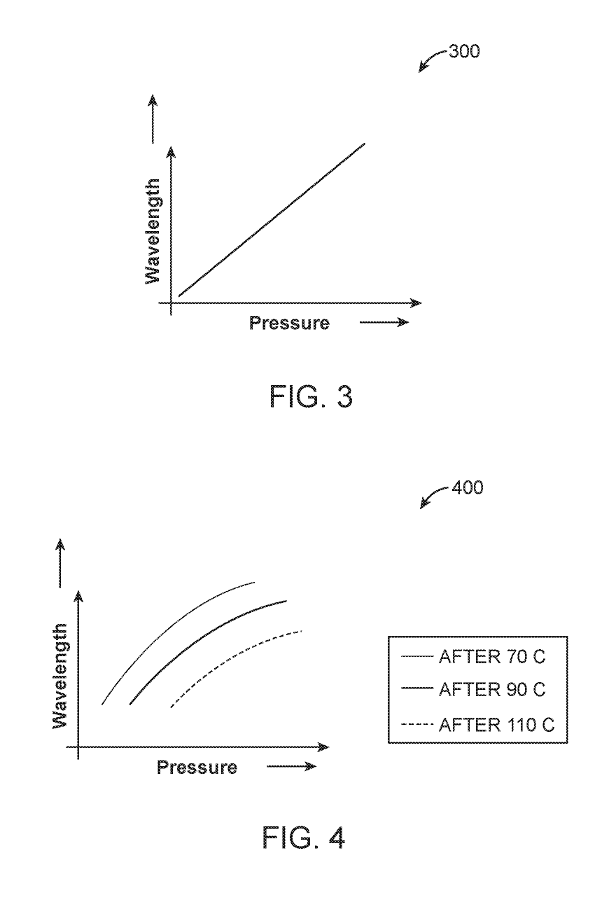

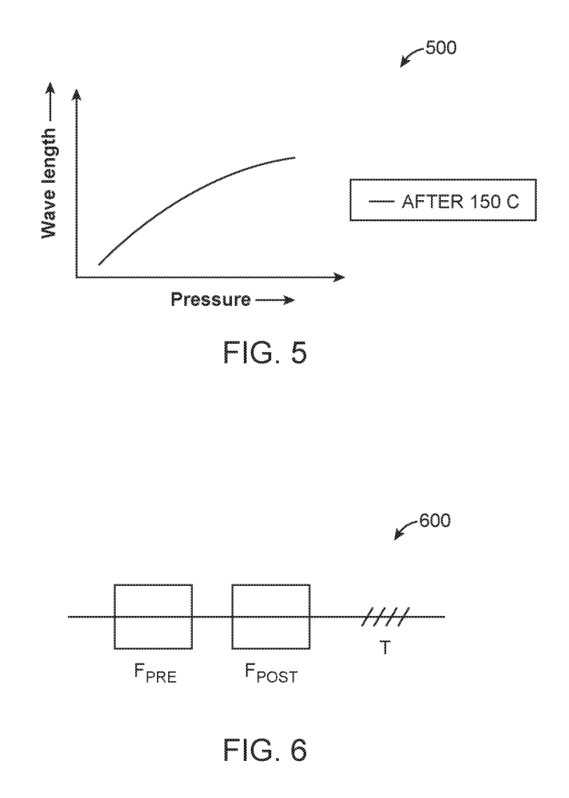

FIG. 1 shows a diagram of the actual response of the F/T sensor prototype to pressure over a series of temperatures for the first time. After each high temperature pressure cycle, the temperature was decreased to 50° C. and another run was made. The response of the sensor decreased in a predicable way, as shown in FIG. 1A. After curing at 150° C., the curves associated with 50° C. test runs after higher temperature runs returned to a single curve of FIG. 2. For convenience, the graphs of FIGS. 1, 1A, and 2 are idealized, respectively, as graphs 300, 400, and 500 of corresponding FIGS. 3, 4, and 5.

There are cases where an F/T sensor of the present disclosure, such as F/T sensor 600 of FIG. 6, could be installed and undergo temperature extremes that are not tracked. In this embodiment, F/T sensor has an uncured F fiber-grating sensing element, FPRE, a cured F fiber-grating sensing element, FPOST, and a temperature element, T. As an example, F/T sensor 600 could be installed in an electrical transformer (not shown) that is not continuously monitored. The transformer could be subject to a short that results in overheating when it is not being monitored in the vicinity of F/T sensor 600. By measuring the difference in outputs between an F/T fiber-grating sensing element that is not cured (here, uncured F fiber-grating sensing element FPRE) and an F/T fiber-grating sensing element that is fully cured (here, cured F fiber-grating sensing element FPOST), the temperature excursion while the F/T fiber-grating sensing elements are not being monitored can be tracked. The difference between the output wavelength of pre-cure F fiber-grating sensing element FPRE and the wavelength of post-cure F fiber-grating sensing element FPOST at normal operating temperatures for the transformer will decrease if F/T sensor 600 is exposed to higher temperatures. Specifically, FIG. 1 shows the response of a pre-cure fiber-grating sensing element the first time it is exposed to an elevated temperature. FIG. 1A shows the reduction in response to pressure changes after exposure to the elevated temperature. By comparing the difference in pressure response between the pre-cure F fiber-grating sensing element FPRE and the post-cure F fiber-grating sensing element FPOST, the maximum temperature excursion can be extracted from the output wavelength changes associated with each F fiber-grating sensing element.

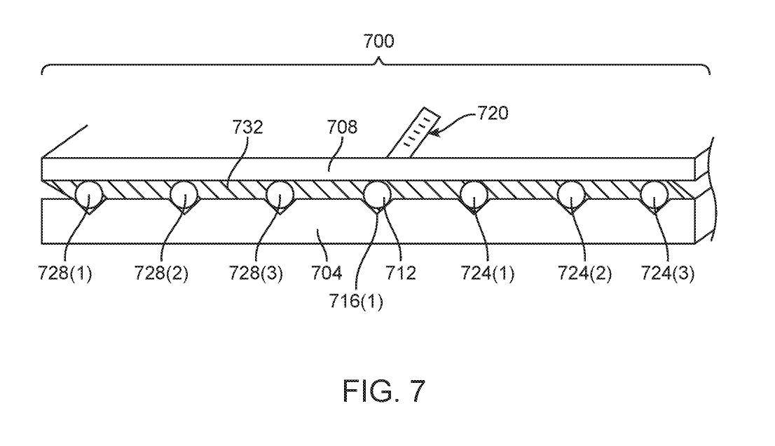

FIG. 7 shows an exemplary F/T fiber-grating sensing element 700 that comprises a lower ceramic v-groove plate 704 and an upper UV transparent quartz plate 708. A central optical fiber 712, which is coated with a deformable material, for example, an organically modified ceramic material referred to under the trademark ORMOCER®, which is owned by the Fraunhofer Gesellschaft zur Forderung der angewandten Forschung e.V., Munich, Germany, is located in a central v-groove 716(1). Central optical fiber 712 contains a fiber grating 720 that is used to support force measurements. Sets of optical fibers 724(1) to 724(3) and 728(1) to 728(3) on each side of central fiber 712 provide reduced loading on the central optical fiber. Upper plate 708, the v-groove plate 704 and optical fibers 712, 724(1) to 724(3), and 728(1) to 728(3) are bonded together with an adhesive 732. An F/T fiber-grating sensing element constructed according to FIG. 7 will have sensitivity to transverse force exerted perpendicular to the upper plate 708. It will also have sensitivity to temperature. To extract force accurately, it is necessary to track temperature, and in prior embodiments, such as embodiments of the '137 application, this was done using a single fiber grating temperature sensor that was isolated from force.

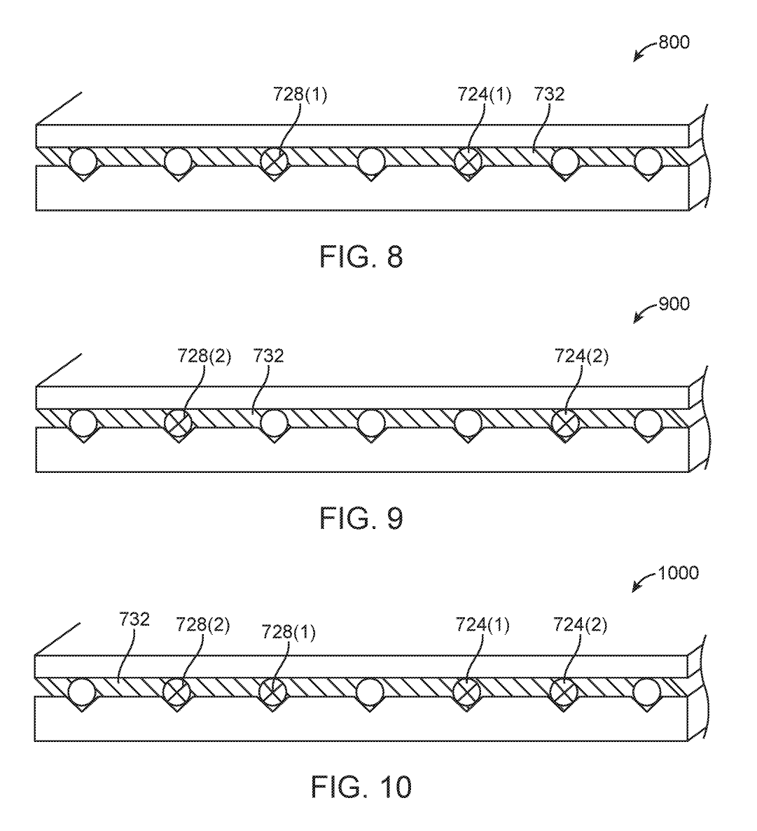

FIGS. 8, 9, and 10 show, respectively, alternative F/T fiber-grating sensing elements 800, 900, 1000 based on some of the same components used to construct F/T fiber-grating sensing element 700 of FIG. 7. In the case of F/T fiber-grating sensing element 800 of FIG. 8, load-reducing optical fibers 728(1) and 724(1) of FIG. 7 have been removed and replaced with more adhesive 732. In the case of F/T fiber-grating sensing element 900 of FIG. 9, load-reducing optical fibers 728(2) and 724(2) of FIG. 7 have been removed and replaced with more adhesive 732, and in the case of F/T fiber-grating sensing element 1000 of FIG. 10, load-reducing fibers 728(2), 728(1), 724(1), and 724(2) of FIG. 7 have been removed and replaced with more adhesive 732. The purpose of removing the load-reducing fibers is to change the response of the corresponding F/T fiber-grating sensing elements 800, 900, and 1000 to force and temperature. Removing (or adding) fibers to other F/T fiber-grating sensing elements having a fixed configuration simplifies the process, and therefore lowers the cost, of creating F/T fiber-grating sensing elements having differing responses. While in the illustrated F/T fiber-grating sensing elements 800, 900, and 1000 of FIGS. 8-10, the absence of the load-reducing fibers is replaced with the adhesive 732, the changes in character could be accomplished, in another manner, such as by creating voids or using a low hardness adhesive in these regions.

By providing F/T fiber-grating sensing elements with differing response characteristics for force and temperature, there are two equations and two unknowns that can be solved. FIG. 11 shows a two element F/T sensor 1100 comprising F/T fiber-grating sensing elements 1104 and 1108 that are designed to have different loads on a central optical fiber 1112 containing fiber gratings 1104A and 1108A with the corresponding respective F/T fiber-grating sensing elements. As should be apparent from examples above, the combinations of F/T fiber-grating sensing elements 1104, 1108 used could involve, for example, varying the number and position of load-reducing optical fibers (not illustrated) as between the F/T fiber-grating sensing elements, creating voids in regions (not shown) where load-reducing optical fibers are not present, or using soft adhesives in those regions, among others, and any suitable combination thereof. A net result when a transverse force (not shown) is applied equally to F/T fiber-grating sensing elements 1104 and 1108, in terms of wavelength shift per unit force, is a differential wavelength shift that is proportional to force. This reduces errors due to unwanted environmental effects that are present in both fiber-grating sensing elements 1104 and 1108. In addition, the various embodiments of FIGS. 7-10 can be used in various combinations.

Another method of varying the load on F/T fiber-grating sensing elements for a fixed loading force is to vary the sizes of the loading areas as between F/T fiber-grating sensing elements. FIG. 12 illustrates this approach in an F/T sensor 1200 to provide two F/T fiber-grating sensing elements 1204 and 1208 having differing responses to force and temperature. F/T fiber-grating sensing element 1204 is designed and configured to have a loading area 1204A that is larger than the loading area 1208A of F/T fiber-grating sensing element 1208. As an example of using F/T sensor 1200, fiber-grating sensing elements 1204 and 1208, having corresponding respective fiber gratings 1212 and 1216, can be placed between insulating boards (not shown) in a transformer under load. Fiber gratings 1212 and 1216, which may be of equal or different lengths, may be located inside similar housing structures and associated materials. In this embodiment, F/T fiber-grating sensing elements 1204 and 1208 are identical except for the sizes of their respective loading area 1204A and 1208A. As a result, the transverse force per unit length over the coated optical fiber 1220 is different over the differing regions of fiber gratings 1212 and 1216. The result is a difference in longitudinal strain applied to the fiber gratings 1212 and 1216 that is proportional to the difference in surface area of F/T fiber-grating sensing elements 1204 and 1208 and the applied force to loading areas 1204A and 1208A.

FIG. 13 illustrates an exemplary moisture (M) sensor 1300 that comprises an optical fiber 1304 that contains, in series, fiber gratings 1308A and 1312A that are spatially separated to create a corresponding pair of M fiber-grating sensing elements 1308 and 1312. Optical fiber 1304 is coated with a deformable material 1316 that may be, for example, ORMOCER®. The region of optical fiber 1304 containing the fiber grating 1308A is coated with a thick layer 1308B of polyimide that may be, for example, 50 microns in thickness. These features create first fiber-grating sensing element 1308. The region of optical fiber 1304 containing fiber grating 1312A is coated with a thin layer 1312B of polyimide that may be, for example, 2 microns in thickness. These features create second fiber-grating sensing element 1312. The differing thicknesses of the two layers 1308B and 1312B of fiber-grating sensing elements 1308 and 1312 results in different moisture and temperature responses and two equations with two unknowns that can be used to measure moisture and temperature. This type of M sensor can be used in combination with the F/T sensors, such as F/T sensors 600, 1100, and 1200 of FIGS. 6, 11, and 12, described above. There is an advantage associated with using moisture/temperature (M/T) sensors with the same underlying deformable optical coating as it saves a strip-and-recoating process, and it has been shown to have response that, in the case of ORMOCER® and a polyimide overcoat, is very similar to that of a polyimide coated and bare fiber combination.

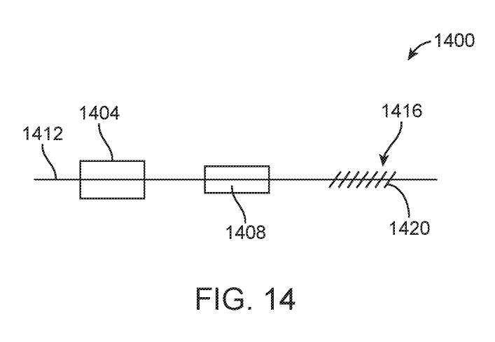

FIG. 14 illustrates another M sensor 1400 having a configuration wherein thick and thin polyimide coatings 1404 and 1408 over corresponding respective fiber gratings (not shown) on an optical fiber 1412 are used in combination with a bare region 1416 over a third fiber grating 1420 that is used for a reference. In this case, bare fiber grating 1420 is used for an absolute temperature reference to cross check the difference in moisture and temperature response of the two other gratings beneath polyimide coatings 1404 and 1408. In this embodiment, relatively hard polyimide coatings 1404 and 1408 expand with increasing moisture content. This exerts uniform transverse force on the underlying deformable elastic coating (not illustrated) (as seen in bare region 1416), which may be, for example, ORMOCER® 2. The elastic coating stretches as it compresses and causes a longitudinal strain on optical fiber 1412 containing the corresponding underlying fiber grating. The elongation of the fiber grating causes it to have an increasing period, which results in an increase in the wavelength of the reflected light, thereby allowing the measurement of moisture content.

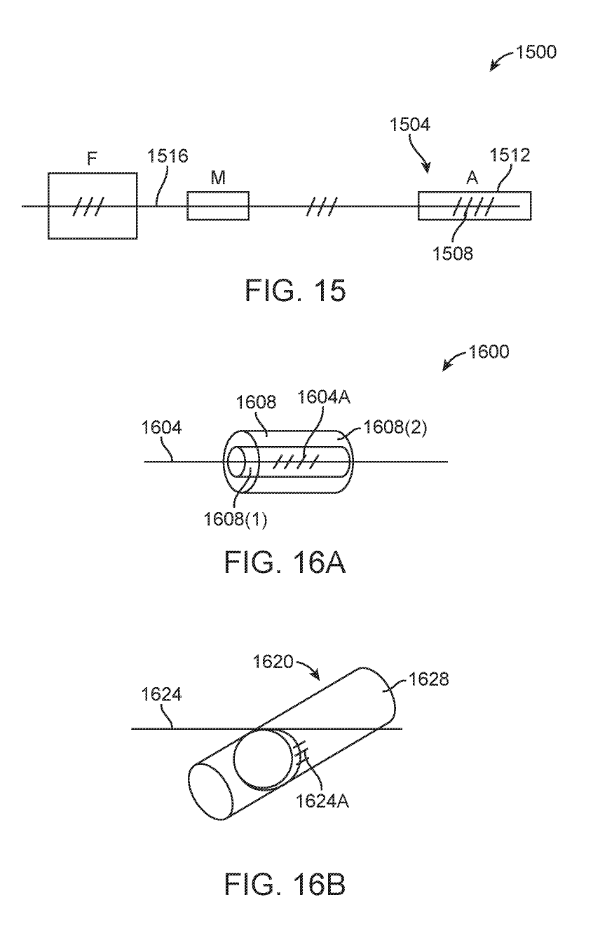

Acoustic (A) sensing capability can be added to sensor of the present disclosure, such as an F/T sensor, an F/M sensor, an M sensor, or force, moisture and temperature (F/M/T) sensor. FIG. 15 illustrates this in the context of an F/M/A sensor 1500 having an acoustic fiber-grating sensing element 1504 formed by coating a fiber grating 1508 with an acoustically sensitive coating 1512, which may be, for example, nylon or HYTREL® to enhance acoustic sensitivity of the optical fiber 1516. Other components of F/M/A sensor 1500 may be the same as or similar to F/M sensor 1400 of FIG. 14. FIG. 16A illustrates an alternative acoustic fiber-grating sensing element 1600 in which a fiber grating 1604A is mounted in a mass of material 1608 comprised of multiple layers, here, two layers 1608(1) and 1608(2), applied to an optic fiber 1604 to enhance its acoustic sensitivity. FIG. 16B illustrates another alternative acoustic fiber-grating sensing element 1620 in which a fiber grating 1624A and its corresponding optic fiber 1624 is wound around a mandrill 1628 that expands and contracts with acoustic pressure.

### Sensor System Considerations

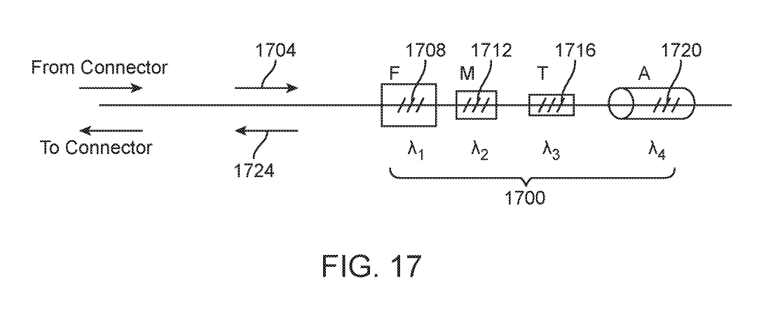

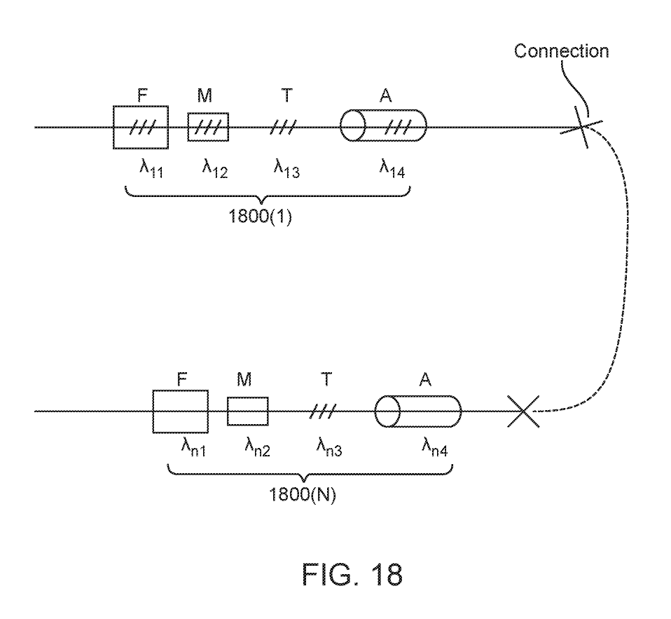

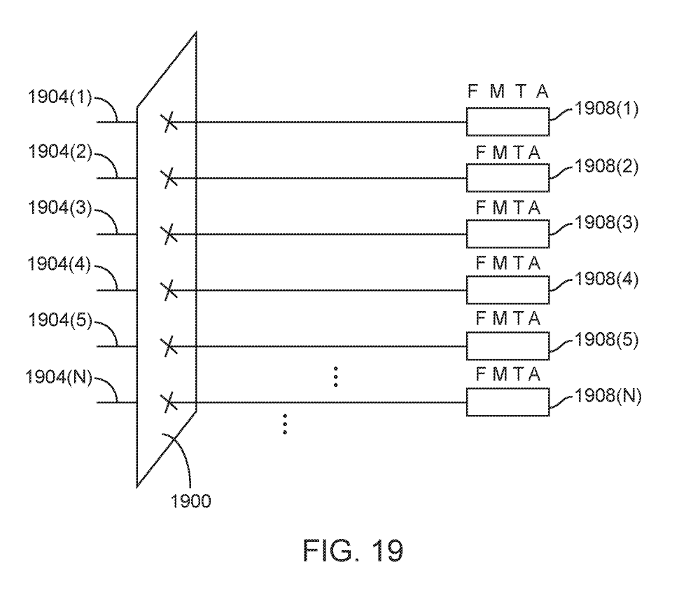

FIG. 17 shows a single-ended F/M/T/A sensor 1700. That is, F/T/M/A sensor 1700 is designed and configured so that a light beam 1704 is reflected by the fiber grating elements 1708, 1712, 1716, and 1720 associated with F/T/M/A sensor 1700 as light beam 1724. As those skilled in the art will appreciate, the signals are encoded in distinct wavelengths λ₁, λ₂, λ₃ and λ₄ that carry the environmental information.

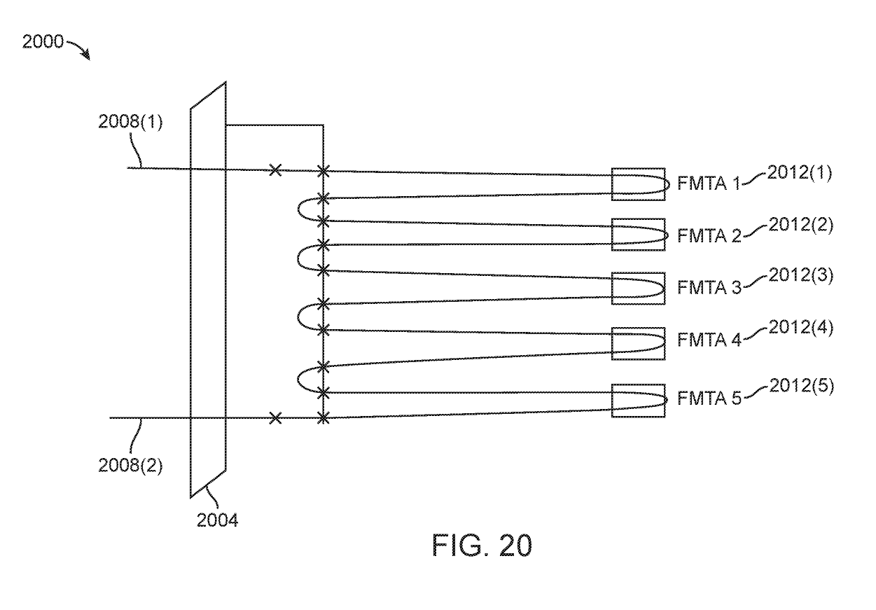

FIG. 18 shows a double-ended configuration of a series of F/M/T/A sensors 1800(1) to 1800(N), each of which has a distinct wavelength band it operates in to avoid wavelength overlaps. F/M/T/A sensors 1800(1) to 1800(N) can be accessed in reflection from either end, thereby providing redundancy in case a line fails and continued access to the line of fiber sensors is needed or desired. Arranging F/M/T/A sensors 1800(1) to 1800(N) also minimizes the number of feed-through lines required per sensor, provided that the number of sensors in line is greater than two. In this context, a “feed-through line” is a line (e.g., optic fiber) that penetrates through an enclosure that contains the one or more sensors in order to conduct the input and/or output signals from the sensor(s) to illumination and/or measurement electronics (not shown). An example of such an enclosure in the context of an electrical transformer is the transformer housing. These features are important, for example, on aircraft and electrical transformers for which lifetimes of 30 to 50 years can be expected and teardown to replace defective fiber connections or sensor could be prohibitively expensive. FIG. 19, in contrast to FIG. 18, illustrates a wall 1900, which may be, for example, a wall of a transformer housing, having a single feed-through line 1904(1) to 1904(5) for each of a plurality (five in this example) of F/M/T/A sensors 1908(1) to 1908(5). The system can be extended to N sensors. FIG. 20 illustrates another feed-through arrangement 2000 in which a wall panel 2004 has two feed-through lines 2008(1) and 2008(2) that provide redundancy for an array of F/M/T/A sensors 2012(1) to 2012(5).

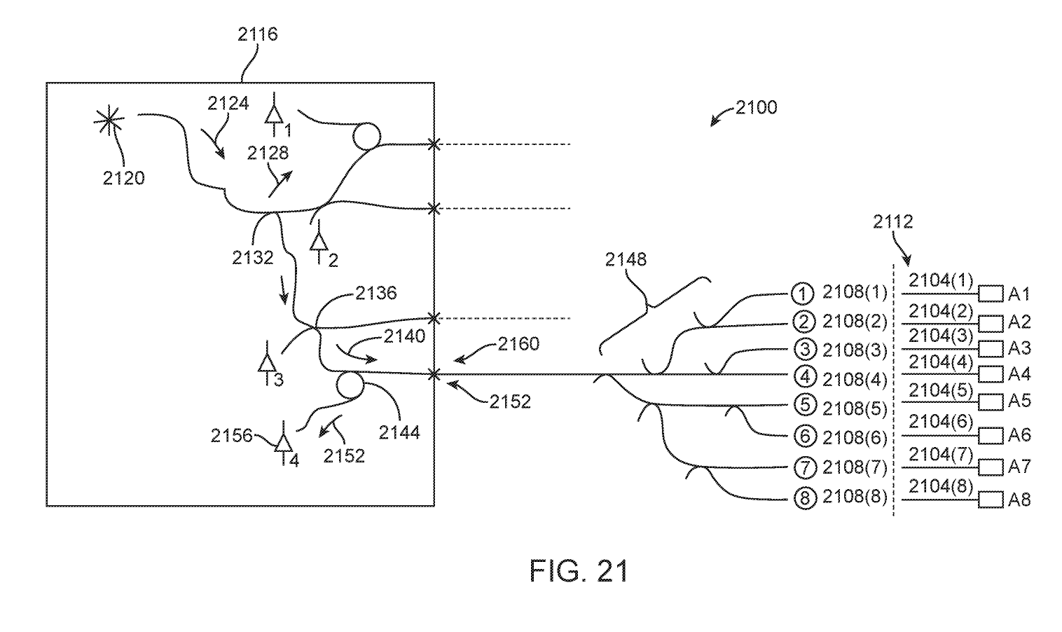

FIG. 21 illustrates a measurement system 2100 for a set of sensors, here eight F/M/T/A sensors 2104(1) to 2104(8), that each have a corresponding feed-through line 2108(1) to 2108(8) that penetrates through a wall 2112, such as a transformer wall. Measurement system 2100 includes a four-port readout system 2116 that has a tunable light source 2120 that injects a light beam 2124 into one end of a beamsplitter 2128 that directs a light beam 2132 to a second beamsplitter 2136 that in turn directs another light beam 2140 past a three-port circulator 2144 and into the input port of a 1×8 power divider 2148. The eight outputs from 1×8 power divider 2148 are then directed to feedthrough lines 2108(1) to 2108(8) that pass through wall 2112 before being connected to F/M/T/A sensors 2104(1) to 2104(8) that all operate at discrete non-overlapping wavelength bands. The reflected light from F/M/T/A sensors 2104(1) to 2104(8) is directed back into 1×8 power divider 2148, and a portion 2152 of the reflected light is directed from the 1×8 power divider back to three port circulator 2144 and onto a fourth readout system output detector 2156 (corresponding to the fourth port 2160 of readout system 2116). In general, readout system 2116 can have N ports rather than the 4 illustrated in FIGS. 21, and 1×8 power divider 2148 could be any 1×M power divider. An alternative to 1×8 power divider 2148 would be a wavelength division multiplexing (WDM) unit (not shown) that splits the spectral range of light source 2120 into eight distinct spectral regions. Each F/M//T/A sensor would be designed to operate in one of these 8 spectral bands. The basic approach described can be extended to WDM units with N distinct spectral regions.

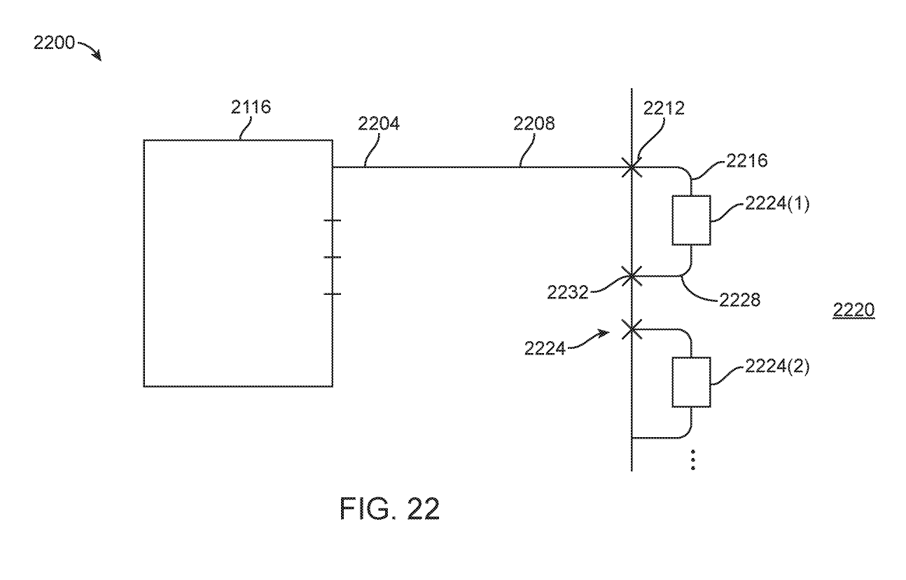

FIG. 22 illustrates another measurement system 2200 that includes the same readout system 2116 of measurement system 2100 of FIG. 21. In measurement system 2200 of FIG. 22, first output port 2204 is connected to a fiber cable 2208 that in turn connects to a feed-through line 2212 that connects to a second fiber cable 2216 interior to an enclosed area 2220 that may be a transformer interior. Second fiber cable 2216 forms an input and output link to an array 2224 of wavelength multiplexed F/M/T/A sensors, here illustrated by F/M/T/A sensors 2224(1) and 2224(2). A third fiber cable 2228 connects to a redundant port 2232 that can be used to connect to F/M/T/A sensors in array 2224 if there is a fiber line failure within enclosed area 2220.

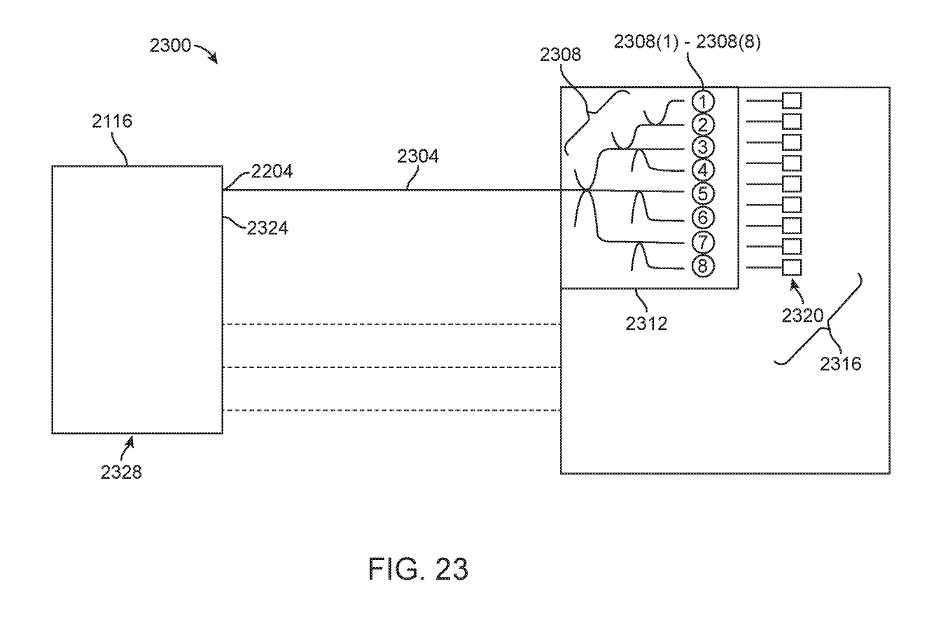

FIG. 23 illustrates yet another measurement system 2300 that includes the same readout system 2116 of measurement system 2100 of FIG. 21. In measurement system 2300 of FIG. 23, first output port 2204 is connected via a fiber cable 2304 to element 2308, which may be a power divider or WDM unit that is located in a region 2312 that is at a more moderate temperature than the temperature associated with parts of an interior region 2316 for which environmental measurements are desired. An array 2320 of sensors is connected to output ports 2308(1) to 2308(8) of element 2308. The locating of element 2308, i.e., the power divider or wavelength division multiplexing unit, in a lower-operating-temperature environment allows lower cost, higher performance components to be used and reduces the number of feed-through lines, here fiber cable 2304 that penetrates a wall 2324 of piece of equipment 2328.

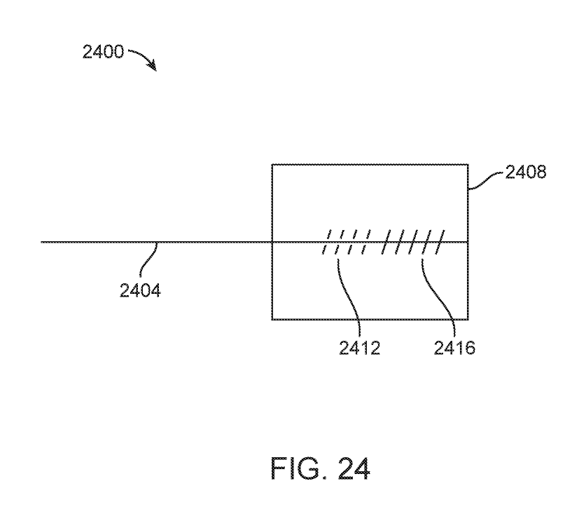

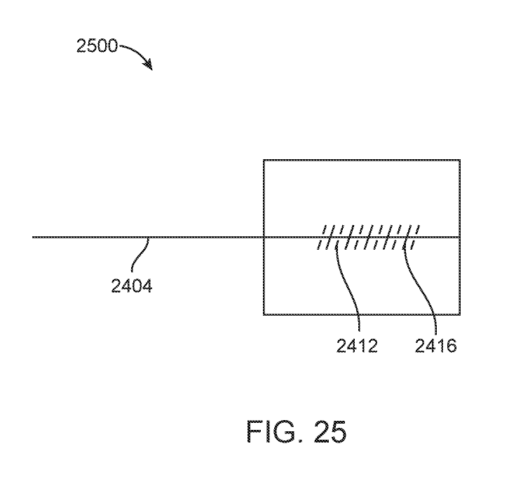

FIG. 24 illustrates an F/T sensor 2400 having an optical fiber 2404 and a deformable jacket 2408 placed around the optical fiber at the locations of multiple fiber gratings having differing wavelengths, here, two fiber gratings 2412 and 2416. When the wavelengths associated with the fiber gratings 2412 and 2416 are widely enough separated, then for a fixed longitudinal strain and temperature, the two fiber gratings 2412 and 2416 will produce measurement signals defined by two linear equations, and if the two-by-two matrix used to solve these equations is well conditioned (the slopes differ significantly), the longitudinal strain and temperature can be accurately measured. FIG. 24 shows the case wherein fiber gratings 2412 and 2416 are spatially separated. However, fiber gratings 2412 and 2416 could be partially or fully overlaid with one another. FIG. 25 illustrates an F/T sensor 2500 in which fiber gratings 2412 and 2416 of F/T sensor 2400 of FIG. 24 are completely superposed with one another. Overlaying fiber gratings 2412 and 2416 has the advantage that the two fiber gratings are physically collocated. Hence they both experience the same strain and temperature. This reduces the possibility of errors induced by strain or temperature gradients across F/T sensor 2500.

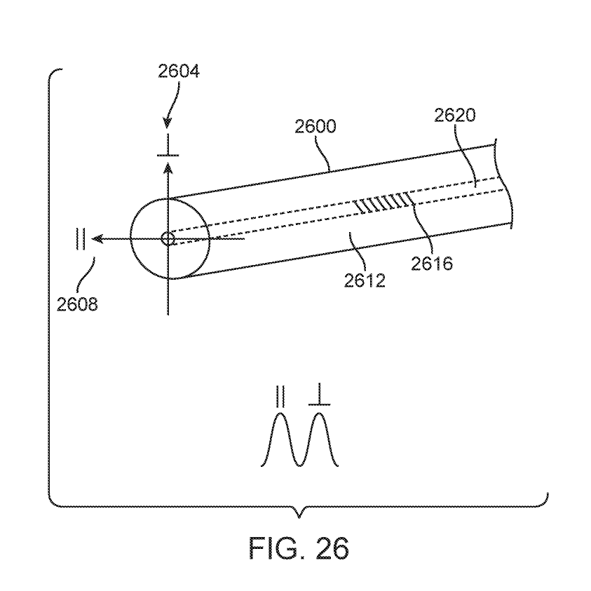

One of the difficulties of using two fiber gratings at significantly different wavelengths with conventional single mode fiber is that the solution matrix may not be well conditioned (able to be solved with high accuracy) unless the two wavelengths are widely separated spectrally. This can require two different light sources and readout units. It also involves introducing a process of writing two closely located fiber gratings. An alternative techniques is to write a single fiber grating onto a birefringent optical fiber 2600, as illustrated in FIG. 26. In birefringent fiber 2600, two transverse axes 2604 and 2608 have different indices of refraction, and writing a single grating on this type of optical fiber results in the two fiber gratings 2612 and 2616 that are collocated on the optical core 2620. This results in two equations with two unknowns, i.e., longitudinal strain and temperature, that may be solved.

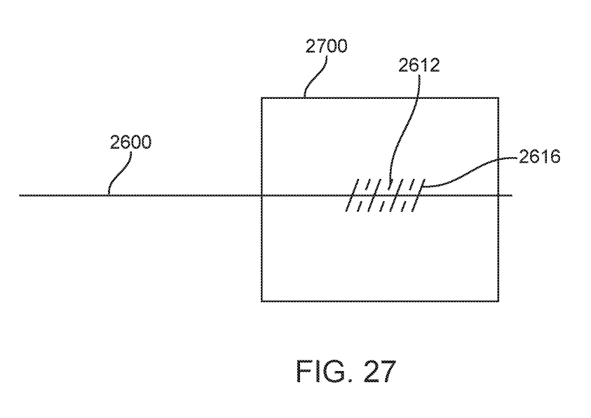

In FIG. 27, birefringent fiber 2600 of FIG. 26, which has a deformable jacket (not illustrated), is inserted into an F/T sensor 2700, and transverse force on the F/T sensor is converted to longitudinal strain, thereby allowing the simultaneous measurement of force and temperature via the wavelength changes associated with the fiber gratings 2612 and 2616. The advantages of the approach of F/T sensor 2700 of FIG. 27 is that birefringent fiber in the form of commercially available polarization-preserving optical fiber can be used effectively for this purpose with a single light source in the telecom C-band. The degree of accuracy that can be achieved depends on the details of the construction of the birefringent optical fiber.

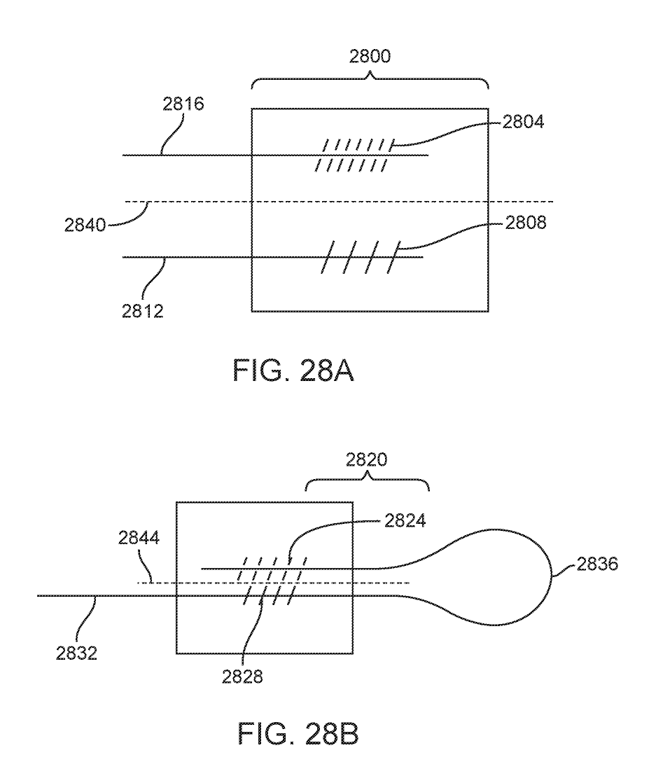

An advantage of the general approach associated with FIGS. 24 to 27 is that there is only one point of entry into and out of the F/T sensor, simplifying strain relief and construction. It is noted that while embodiments described above in connection with FIGS. 6 to 18 have physically discrete fiber-grating sensing elements, the embodiments associated with FIGS. 24 to 27 are also considered to each have multiple fiber-grating sensing elements though they are not necessarily physically discrete from one another as in the embodiments of FIGS. 6 to 18. In the cases of FIGS. 24 and 25, the differing fiber-grating sensing elements correspond, respectively, to the fiber gratings 2412 and 2416 of differing wavelengths. Similarly, in the case of FIGS. 26 and 27, the differing fiber-grating sensing elements correspond, respectively, to the fiber gratings 2612 and 2616. Similar fiber-grating sensing elements are also found in the embodiments of FIGS. 28A to 31.

FIG. 28A illustrates an exemplary F/T sensor 2800 having differing fiber gratings 2804 and 2808 on differing fiber segments, here two separate optic fibers 2812 and 2816. The fiber gratings 2804 and 2808 are spatially displaced, which may not be desirable if temperature gradients are an issue, and require two separate optical fibers 2812 and 2816 that may increase system cost. FIG. 28B illustrates an F/T sensor 2820 having similarly located differing fiber gratings 2824 and 2828, but in a configuration that uses a single input/output optical fiber 2832. The input/output optical fiber 2832 enters F/T sensor 2820 and supports fiber gratings 2824 and 2828, which are connected via a loop 2836 that may be external to or located within the F/T sensor.

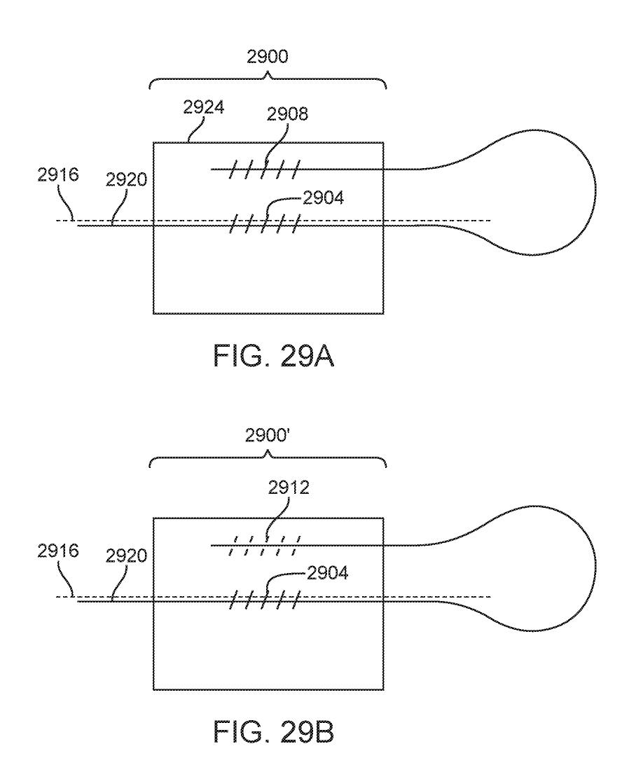

In FIGS. 28A and 28B, the locations of fiber gratings 2804, 2808, 2824, and 2828 in F/T sensors 2800 and 2820 are symmetric about a central axis 2840 and 2844 of each of the F/T sensors and would be expected to experience the same force with a symmetrical loading into and out of the page containing FIGS. 28A and 28B. FIGS. 29A and 29B illustrate, respectively, F/T sensors 2900 and 2900′ that are similar to F/T sensor 2800 except that the fiber gratings 2904 and 2908 (FIG. 29A) and 2904 and 2912 (FIG. 29B) in each of the F/T sensors are located asymmetrically relative to a central axis 2916. In particular, fiber gratings 2904, 2908, and 2912 in each F/T sensor 2900, 2900′ are placed at locations where applied forces and temperatures differ from one location to the other. In FIG. 29A, an input optical fiber 2920 extends into F/T sensor 2900. In this embodiment, first fiber grating 2904 is placed near central axis 2916, while second fiber grating sensor 2908 is placed near an edge 2924 of F/T sensor 2900. In this example, fiber gratings 2904 and 2908 may have the same wavelength as one another. The fiber gratings 2904 and 2908 can also be configured to be different wavelengths so that their wavelength can be measured independently. If F/T sensor 2900 is placed in an isothermal environment and the bonding processes and procedures for both fiber gratings 2904 and 2908 are similar, the differential wavelength shift between the two should be due to force only. In the absence of differential force, first fiber grating 2904 will shadow second fiber grating 2908 if they are initially selected to be the same or very nearly similar wavelength. As the differential force between first and second fiber gratings 2904 and 2908 increases, the amplitude of the return signal will increase, and the spectral signal will broaden if the two signals from the fiber gratings 2904 and 2908 are mixed. In F/T sensor 2900′ of FIG. 29B, second fiber grating 2908 of F/T sensor 2900 of FIG. 29A is replaced by replacement second fiber grating 2912 that is offset in wavelength. The wavelength difference between the fiber gratings 2904 and 2912 in FIG. 29B can be small and may be set so that the linear portions of the spectral reflectance overlap resulting in a maximum change in amplitude with small force changes. Alternatively, the offset wavelengths between fiber gratings 2904 and 2912 may be made great enough so that overlap will not occur over the force and temperature ranges of interest. In this case, differences in force would be determined by absolute wavelength measurements.

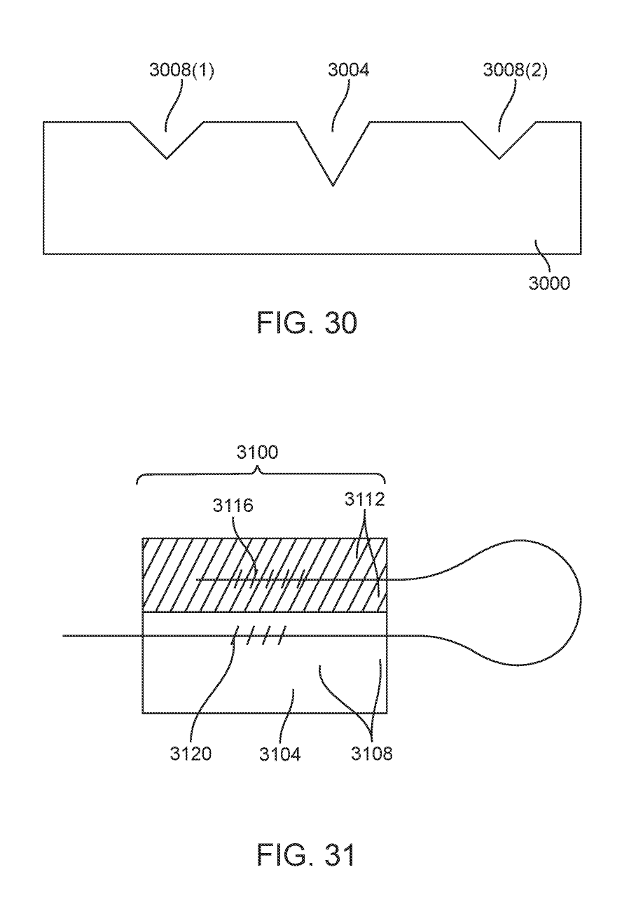

While the spatial locations of the fiber gratings 2904 and 2912 may be sufficient to create significant differential force between them, measures can be taken to enhance the differential response during application of force to F/T sensor 2900′. FIG. 30 illustrates an underlying support plate 3000 for an F/T sensor (not shown) of the present disclosure that is fabricated so that a central groove 3004 is deeper than outer grooves, here outer grooves 3008(1) and 3008(2). When one or more optical fibers (not shown) having elastic coatings and fiber gratings are placed into groove 3004 and at least one of grooves 3008(1) and 3008(2) and bonded in place, a differential response to force results. Other modifications of underlying plate 3000 that vary with the localized force with load could be used for a similar effect.

FIG. 31 illustrates an F/T sensor 3100 having an underlying plate 3104. In this example, underlying plate 3104 could have grooves or like structures (not shown) of constant or differing depths (see FIG. 30 for an example of a suitable underlying plate 3000 having grooves 3004, 3008(1), and 3008(2) of differing depths). In this embodiment, one or more bond materials in regions 3108 and 3112 would be designed to have differing hardnesses to create a force differential between fiber gratings 3116 and 3120 that have elastic coatings (not illustrated). The differences in hardness could be achieved, for example, by using different bonding materials. An alternative would be to use a single bonding material and change the properties of a selected region by one or more of the following processes: 1) adding a chemical to change hardness; 2) changing the thermal cure cycle of a region; or 3) in the case of UV curable bonding material, changing the UV exposure time for curing. As an example, a mask could be applied over a region to reduce exposure to thermal or UV radiation.

The embodiments associated with FIGS. 6, 11, 12, 28, 29 and 31 of an F/T sensor use separate force inducing elements to create differential force and temperature responses. This produces two response curves that depend on the variables of force F and temperature T and a measureable wavelength. The simplest case is when both responses are linear equations of the form λ₁=α₁F+β₁T and λ₂=α₂F+β₂T, wherein F is the transverse force on the sensor, T is the temperature, X is the measured wavelength, and α and β are coefficients associated with each F/T sensor. These form a simple set of linear equations. The accuracy with which force and temperature may be measured depends on the differences in slope between the two equations, the accuracy with which wavelengths may be measured, and other factors such as the stability of the response of the sensor over time. While the simple example above contains linear equations, in general the response curves could be higher-order polynomial equations or complex curves that may be modeled. Those skilled in the art will readily appreciate how to handle solving the equations involved regardless of their form.

The coefficients α₁, β₁, α₂, and β₂ in the case of linear response can be determined by running the sensors through calibration by fixing temperature and varying force or fixing force and varying temperature. They can then be stored in a read out unit to convert wavelength measurements λ₁ and λ₂ into force F and temperature T outputs. In the case of fitting to higher order polynomials additional coefficients are calculated to second, third and higher order terms as needed and stored to perform the same function of generating the output F and T but with higher accuracy.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure.

Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A sensor, comprising:
a first fiber-grating sensing element designed and configured to sense a first environmental input; and
a second fiber-grating sensing element designed and configured to sense the first environmental input;
wherein the first and second fiber-grating sensing elements are configured, constructed, and/or deployed so as to have differing measured responses to the first environmental input.

2. The sensor according to claim 1, wherein the first environmental input is force.

3. The sensor according to claim 2, wherein:
the first fiber-grating sensing element comprises a first fiber grating and a first adhesive in a first cure state and surrounding the first fiber grating; and
the second fiber-grating sensing element comprises a second fiber grating and a second adhesive in a second cure state different from the first cure state and surrounding the second fiber grating.

4. The sensor according to claim 2, wherein:
the first fiber-grating sensing element has a first area, associated with a first fiber grating, designed and configured to create a first pressure in response to the force; and
the second fiber-grating sensing element has a second area, associated with a second fiber grating, designed and configured to create a second pressure in response to the force;
wherein the second area is different from the first area so that the second pressure is different from the first pressure.

5. The sensor according to claim 2, wherein the first fiber-grating sensing element includes a first fiber grating and has a first number of load-bearing optical fibers, and the second fiber-grating sensing element includes a second fiber grating and has a second number of load-bearing optical fibers different from the first number so that strain induced into the first and second fiber gratings in response to application of the force differs as between the first and second fiber gratings.

6. The sensor according to claim 2, wherein the first fiber-grating sensing element has at least one first load bearing optical fiber of a first length and the second fiber-grating sensing element has at least one second load bearing optical fiber of a second length different from the first length.

7. The sensor according to claim 1, wherein the first environmental input is moisture and the first fiber-grating sensing element has a first fiber grating at a first region and a first moisture-sensitive material coupled to the first region so as to cause a first change in length of the first fiber grating with changes in moisture to which the first moisture-sensitive material is exposed.

8. The sensor according to claim 7, wherein the second fiber-grating sensing element has a second fiber grating at a second region and a second moisture-sensitive material coupled to the second region so as to cause a second change in length of the second fiber grating with changes in moisture to which the second moisture-sensitive is exposed such that the second change in length is different from the first change in length.

9. The sensor according to claim 8, wherein the first and second moisture-sensitive materials have differing thicknesses.

10. The sensor according to claim 8, wherein the first moisture-sensitive material is different from the second moisture-sensitive material.

11. The sensor according to claim 1, wherein the first environmental input is force and the sensor further comprises:
a third fiber-grating sensing element designed and configured to sense moisture; and
a fourth fiber-grating sensing element designed and configured to sense the moisture;
wherein the first and second fiber-grating sensing elements are configured so as to have differing measured responses to the moisture.

12. The sensor according to claim 11, further comprising an acoustic sensor comprising a fifth fiber-grating sensing element present on an optical fiber on which the first through fourth fiber-grating sensing elements are also present.

13. The sensor according to claim 12, wherein the fifth fiber-grating sensing element comprises a multilayer mass of material surrounding a fiber grating.

14. The sensor according to claim 12, wherein the fifth fiber-grating sensing element comprises a fiber grating and a mandrel, wherein a portion of the common optical fiber containing the fiber grating is wrapped around the mandrel.

15. A sensor, comprising:
a pair of pressure transduction plates;
an optical fiber having a first fiber grating and a second fiber grating and being coated with an elastic deformable material;
wherein a portion of the optical fiber is bonded between the pressure transduction plates so that the first and second fiber gratings are located between the pressure transduction plates and so that, upon application of a transverse force orthogonally to a plane of the pressure transduction plates, the elastic deformable material causes longitudinal strain on the first and second fiber gratings.

16. The sensor according to claim 15, wherein the first and second fiber gratings are spaced from one another along the optical fiber.

17. The sensor according to claim 15, wherein the first and second fiber gratings are collocated with one another.

18. The sensor according to claim 15, wherein the first and second fiber gratings are connected by a loop that displaces the first and second fiber gratings transversely to a surface of the pressure transduction plates.

19. The sensor according to claim 18, wherein the pressure transduction plates includes a lower plate having a first groove under the first fiber grating and a second groove under the second fiber grating, wherein the first groove is not identical to the second groove.

20. The sensor according to claim 18, wherein the sensor has differing pressure responses as between the first and second fiber gratings.

21. The sensor according to claim 15, wherein the optical fiber is birefringent and the first and second fiber gratings are formed by writing a single fiber grating on the birefringent optical fiber.

22. A sensor system for measuring an environmental input other than temperature, comprising:
a first fiber-grating sensing element designed, configured, and/or deployed to sense the environmental input with a first response to the environmental input;
a second fiber-grating sensing element designed, configured, and/or deployed to sense the environmental input with a second response to the environmental input that is different from the first response;
a readout system designed and configured to:
receive a first signal from the first fiber-grating sensing element that represents the first response;
receive a second signal from the second fiber-grating sensing element that represents the second response; and
determine a measurement for the environmental input by effectively solving two equations having two unknowns representing, respectively, the environmental input and temperature.

23. The sensor system according to claim 22, wherein the effective solving of the two equations includes using a lookup table.

24. The sensor system according to claim 22, wherein the environmental input is force.

25. The sensor system according to claim 22, wherein the environmental input is moisture.
